(19) United States
(12) Patent Application Publication
(10) Pub. No.: US 2023/0211914 A1
(43) Pub. Date: Jul. 6, 2023

(54) METHOD AND APPARATUS FOR LABEL APPLICATION

(71) Applicant: Canadian Bank Note Company, Limited, Ottawa (CA)

(72) Inventors: Barry GURBERG, Orleans (CA); Vasilios KOUTSOUBIDIS, Gatineau (CA); Jeffery MCDONALD, Ottawa (CA)

(73) Assignee: Canadian Bank Note Company, Limited, Ottawa, ON (CA)

(21) Appl. No.: 17/928,055

(22) PCT Filed: May 27, 2021
(86) PCT No.: PCT/CA2021/050720

§ 371 Date: Nov. 28, 2022

(30) Foreign Application Priority Data
May 28, 2020 (CA) 3,081,515

(51) Int. Cl. B65C 1/02; B65C 9/36; B65C 9/30; B65C 1/04; B65C 9/40

(52) U.S. Cl. CPC B65C 1/021; B65C 9/36; B65C 9/30; B65C 1/042; B65C 9/40

(57) ABSTRACT

Label application system and method for applying labels to packages of various sizes and shapes, adaptable for use in a wide range of facilities. The system comprises a gripper for retrieving the label, wherein the gripper releasably and minimally contacts the adhesive side of the label. The system further comprises one or more applicators for firmly applying the label to the package. Movement of the gripper and/or applicators is controlled by a servo-actuated delta-type robot.

### FIELD

The invention relates to the automated application of labels to objects or packages.

### BACKGROUND

As on-line shopping increases in popularity, processes relating to product and package shipment become increasingly important. One step that must be carried out prior to shipment is the application of one or more labels on the packages.

Labeling apparatuses presently available may be able to handle only a limited range of predetermined package sizes and/or shapes. In some industries, packages may come in a large variety of sizes and shapes, including for example cylindrical shapes, and irregular shapes.

Typically, labelling apparatuses use a vacuum, bellows or similar features to hold, by suction, a label prior to and during application. Such features contact the label on the non-adhesive side. This type of set-up requires vacuums and/or compressors. Vacuums and compressors necessitate the presence of extensive auxiliary equipment, high power usage and require significant maintenance. Moreover, labeling apparatuses may require a large set-up such as a conveyor belt system, such as taught in U.S. Pat. No. 9,352,872. This is not suitable for a small plant or processing centre. Thus, vacuums and compressors are not suitable for all locations—particularly those with limited space, limited power and/or limited expertise to repair or set up equipment. Additionally, vacuums and/or compressors may necessitate more down time, increase product contamination and increase maintenance interventions.

Moreover, some products, objects or packages may require specific handling procedures. For example, products which are subject to excise duties, such as alcohol, tobacco and cannabis, may be labeled with an excise stamp prior to sale. In some cases, the excise stamp must be applied so as to seal the package, illustrating that it has not been tampered with (and, on the other hand, must tear easily if the package is tampered with). The adhesive on these stamps may be strong, making handling of the labels or stamps difficult. Further, the stamp must be applied in such a manner that other information on the package is not obscured.

Due to the challenges of applying labels, particularly excise stamps, some producers/manufacturers hire staff to apply stamps manually. This is not cost effective.

Accordingly, methods and apparatuses for applying labels, including excise stamps, to a variety of object/package sizes and shapes, are needed. Also needed are methods and apparatuses for applying labels in a precise manner for compliance with legislation relating to, for example, excise stamps. Also needed are methods and apparatuses for applying labels which are relatively inexpensive, are reliable without frequent maintenance, do not require extensive setup such as vacuums and/or compressors, and/or may be used in relatively small spaces.

### SUMMARY

In an embodiment, an automated label application system or apparatus for labeling an object comprises a gripper and one or more applicators. The gripper retrieves the label and releasably and minimally contacts the adhesive side of the label. The one or more applicators apply the label onto the object. Movement of the gripper and/or the one or more applicators is actuated by a robot. The robot may be a delta-type robot. The robot may be controlled by a servo motor.

In embodiment, the gripper comprises a plurality of pointed protrusions.

In an embodiment, a method for automatically applying labels to packages comprises the steps of providing a label; retrieving and gripping the label by means of a gripper, the gripper releasably and minimally contacting the adhesive side of the label; guiding the label to the package; and applying the label to the package by means of one or more applicators, wherein the gripper and the one or more applicators are actuated by a robot. In some embodiments, the robot may be a delta-type robot. The robot may be controlled by a servo motor.

In embodiment, the gripper comprises a plurality of pointed protrusions.

### BRIEF DESCRIPTION OF THE DRAWINGS

FIG. 1 is a perspective view of an embodiment of the label application system or apparatus, along with an exemplary setup including label dispenser and package delivery system.

FIG. 2 is a lower perspective view of an embodiment of the gripper head.

FIG. 3 is an upper perspective view of an embodiment of the gripper head.

FIG. 4 is a perspective view of an embodiment of the gripper.

FIG. 5 is a front perspective view of an embodiment of the lock nut.

FIG. 6 is an upper perspective view of an embodiment of the lock nut.

FIG. 7 is a perspective view of an embodiment of a package delivery system.

FIG. 8 is a perspective view of another embodiment of a package delivery system.

FIG. 9 is a perspective view of an embodiment of a package delivery system illustrating multiple cassettes or trays.

### DETAILED DESCRIPTION

“Label” is defined herein as a slip of paper, cloth, or other material, marked or inscribed, for attachment to something to indicate its manufacturer, nature, ownership, destination, or other identification and includes shipping labels, excise stamps and similar items applied to objects or packages. The label may include a liner or backing, or may be linerless. The label may be pressure sensitive or it may be a dry label.

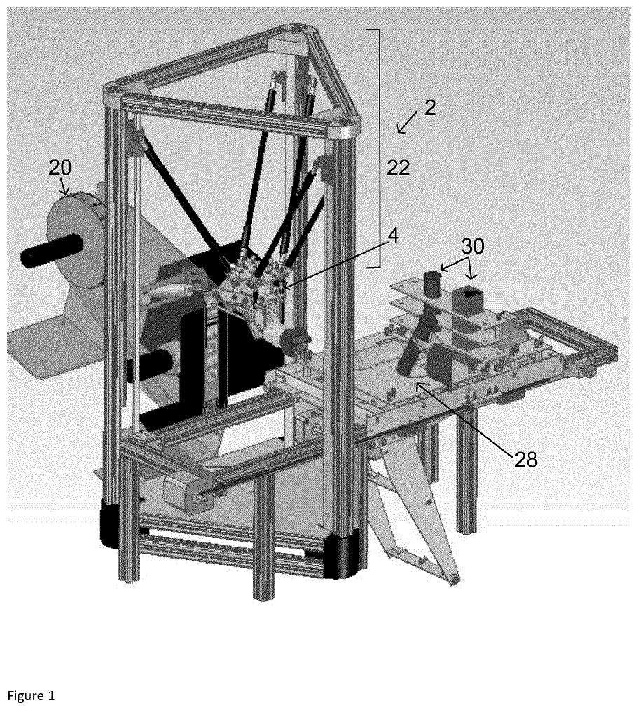

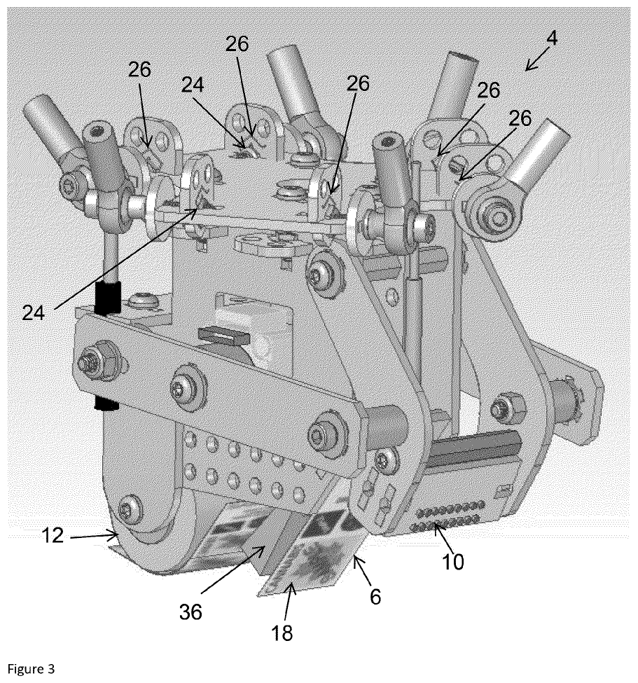

As illustrated in FIGS. 1-3, a label application system or apparatus (2) comprises a gripper head (4) which retrieves the label (6) and applies it to an object or package (30). The gripper head (4) comprises gripper (10) for retrieving the label, and one or more applicators. The applicators may include a first applicator (14) for placement of the label on the package, and/or a second applicator (12) for, if needed, pressing the label onto the package more firmly or applying the label onto a second surface of the package. The first applicator (14) may comprise, for example, a roller, brush or suction cups. In an embodiment, the roller may consist of a stack of washers. The suction cups may be bellows shaped. The gripper (10) releasably grips the adhesive side of the label, making minimal contact, such that the label is not damaged, and such that buildup of adhesive on the gripper (10) is avoided.

In an embodiment, the second applicator (12) may comprise a roller. The roller firmly applies the label onto the package even in the case where the label must be applied onto two different surfaces of the package (e.g. around a corner). The second applicator may additionally or alternatively comprise a plunger or suction head (not shown) suitable for applying labels to a cylindrical shape or curved surface. The second applicator may additionally or alternatively comprise a brush, foam implement or suction cups. The suction cups may be bellows shaped.

Multiple movements of the gripper head may be required to cause the one or more applicators to fully apply the label to the object. If the label is to be placed on a curved surface, or a 90 degree corner, the system is programmed to follow that shape.

In an alternative embodiment, the gripper and the one or more applicators may be separately located and controlled, with the steps of placing the label on the package and firmly applying the label being carried out at separate stations. In this embodiment, the gripper may be located on the gripper head with the one or more applicators being located on a separately controlled head.

In an embodiment, the one or more applicators may allow for wrap-around application of the label—i.e. application of the label to two different surfaces of the package, such as two surfaces at 90 degrees to each other.

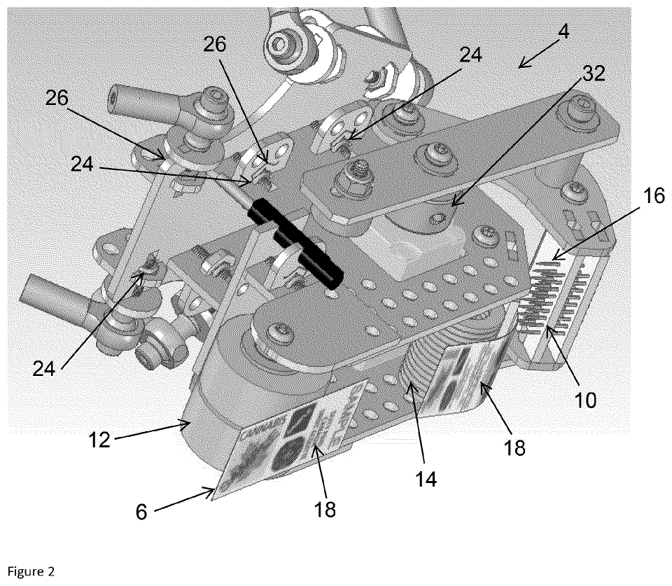

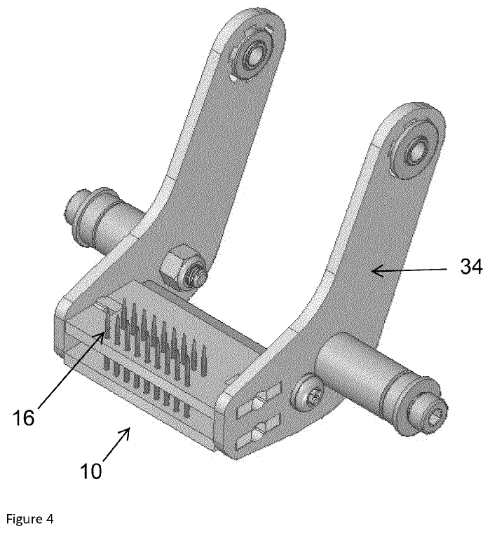

As illustrated in FIGS. 2-4, in an embodiment, the gripper (10) comprises a plurality of pointed protrusions such as a line of pins or a bed of pins (16) which make minimal contact with the adhesive side (18) of the label. Minimal contact is understood to refer to minimum sufficient contact between the pointed protrusions and the label to allow the gripper to carry the label, such that the label is correctly positioned for application on the object. As the label only makes contact with the tapered points of the pins, the relative area of contact is small. For example, less than 20%, less than 10%, less than 5%, less than 4%, less than 3%, less than 2%, less than 1%, less than 0.5% or between 0.5% to 1%, 1%-10%, 1%-5%, 1%-4%, 1%-3% or 1%-2% of the surface area of the label may contact the gripper (10). The optimal number of pointed protrusions may be determined based on the size of the label to be applied, however preferably the pointed protrusions should form at least two rows in order to hold the label in a flat position. A single row of pointed protrusions will allow the label to pivot, which is undesirable. In an embodiment, the gripper (10) may comprise at least 6, at least 8, at least 10, at least 12, at least 14, at least 16, at least 18 or at least 20 pointed protrusions. In an embodiment, the gripper (10) may comprise less than 30, less than 28, less than 26, less than 24, less than 22, or less than 20 pointed protrusions. For example, in an embodiment, there must be at least 2 rows, with each row comprising at least three pointed protrusions. In the embodiment illustrated in FIGS. 2-4, the gripper comprises 18 pointed protrusions, in 2 rows of 9 protrusions each.

Minimal contact between the label (6) and the gripper (10) minimizes the buildup of adhesive on the gripper (10) and reduces downtime needed for cleaning the gripper and apparatus. Therefore, it is desirable to include the minimum number of pointed protrusions, but such minimum number must be sufficient to allow for stable gripping of the label and to allow for retrieving of the label, which may, in some embodiments, require pulling the label off a liner.

The gripper (10) may be independently movable with respect to the rest of the gripper head (4), allowing the gripper (10) to move between a label-retrieving position, a label-carrying position and a position for transferring the label from the gripper (10) to the object. This may be achieved by any means suitable such as, for example, bearings (32) connected to the gripper (10) by means of arms (34). In particular, the portion of the gripper comprising the plurality of pointed protrusions may be operable to open away from the anvil (36) portion of the gripper, effectively opening the “jaws” of the gripper. When the gripper is in a label-retrieving position, the pointed protrusions face outward (i.e. the “jaws” are open) so as to contact the label. When the gripper is in a label-carrying position, the “jaws” are open; the pointed protrusions face inward or downward. When the gripper holds the label, the dry (non adhesive side) side of the label rests against the anvil (36) of the gripper. To affix the label, the gripper moves up against the object, and the gripper again opens its “jaws”, moving the pointed protrusions away from the anvil, to release the gripped end of the label.

The label may be retrieved from any suitable label dispenser (20). For example, the label dispenser may provide labels in a roll format as illustrated in FIG. 1, or may comprise a hopper of labels.

There are different ways adhesive could be added to the labels. Any suitable adhesive and adhesive application method could be used. Labels, especially those in a roll format, may be provided with adhesive already applied. Or, the adhesive could be applied in a separate step prior to or after application of the label. For example, a hot melt adhesive could be applied to the label prior to application of the label onto the package, or the label may be affixed to the package by ultrasonic bonding.

The label application system (2) further comprises means for moving or manipulating the gripper head. Such means may comprise a motor such as a servo, controlling a suitable robot such as a delta-type robot (22). Pneumatic equipment such as compressors or vacuum pumps are not required, but could be used if desired. The robot may have full range of movement in all directions (x, y and z axes). A servo driven system may be suitable for a wide variety of locations, as there are fewer limitations as to space. The absence of compressors and vacuum pumps simplifies maintenance and reduces space requirements for the system.

In an exemplary embodiment (see FIG. 1), the delta-type robot is a linear delta-type robot and comprises arm pairs attached to carriages by means of suitable joints such as ball joints, where the carriages slide up and down along parallel rails. The arm pairs are attached to the gripper head (4) by means of universal joints. Movement of the carriages is actuated by servo motors.

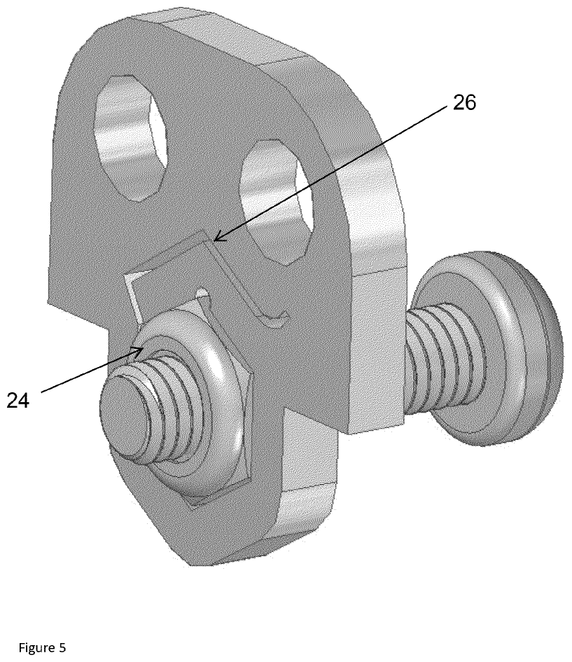

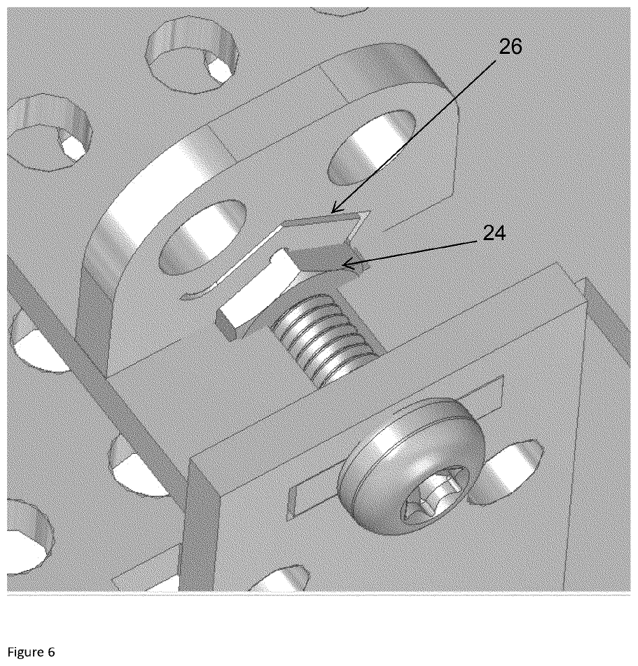

As illustrated in FIGS. 1-3, 5 and 6, the gripper head (4) may be attached to the arms of the robot (22) using lock nuts (24) or nut wrenches which allow for secure fastening without welding, even when the nut and bolt are subjected to vibrations. A relief (26) built into the gripper head (4) may be further provided. The relief (26) may include, for example, a suitable shape to accommodate the lock nut (24), such as a hexagonal shape, which holds the lock nut in place. The relief may comprise a spiral shape which acts as a spring, to hold the nut in place while a bolt or screw is inserted. This allows the bolt to be easily installed and tightened. Any suitable number of lock nuts (24) may be provided, such as 3 or more, 4 or more, 5 or more, or 6 or more.

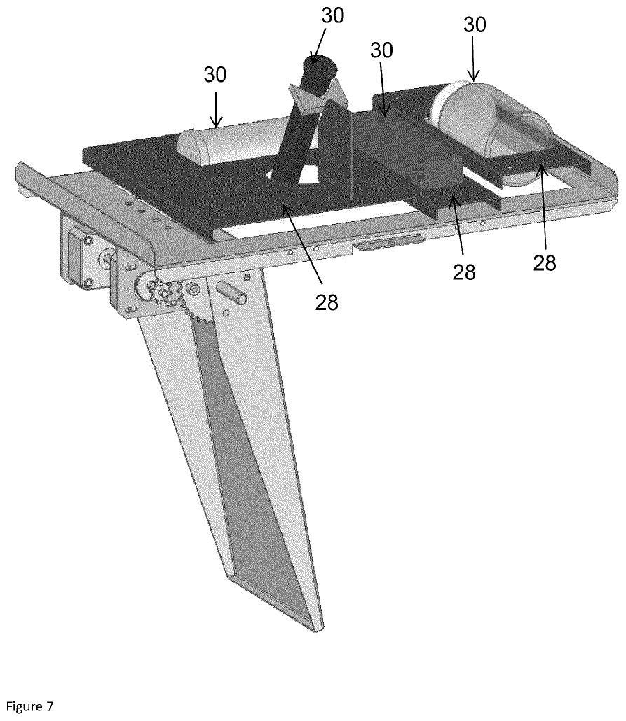

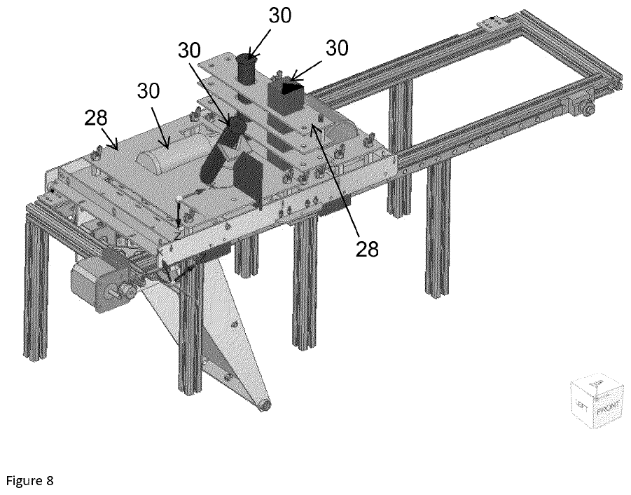

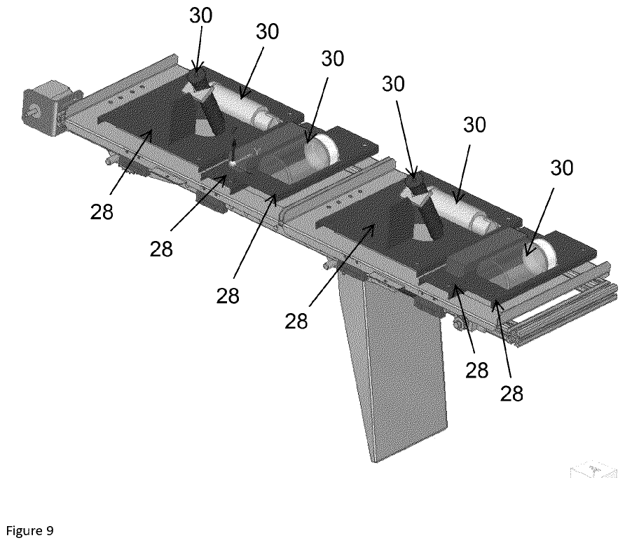

As illustrated in FIGS. 7-9, the label application system or apparatus (2) may be used in conjunction with any suitable package delivery system. In an embodiment, the packages may be shuttled to the label application system or apparatus one at a time or on cassettes or shuttle trays (28). The cassettes or trays (28) can be preloaded at the time of packaging and stored on carts or racks until labeling is required. In an embodiment, the packages may be organized according to size and shape so that packages on a given cassette or tray are identical in size and shape, improving efficiency.

Shuttling the cassettes or trays into the reach of the robot keeps the operator safe, and increases the throughput of the machine. Without this, the machine functions, but at a slower rate.

In some embodiments, it may be desirable to keep the packages (30) locked or secured prior to labeling. Loading and unloading of the cassettes (28) may be automated and the labeling step may be followed by boxing of the packages (30).

In another embodiment, the packages (30) may be placed on the label application system or apparatus (2), and once the labeling step is complete, the package (30) may be dropped through a trap door (32). The trap door may conveniently lead to a conveyor or box. Cardboard trays could be incorporated to allow final boxing to take place immediately after label application.

The label application system or apparatus (2) is used as follows. The label dispenser (20) is positioned so as to allow one label at a time to be retrieved by the gripper (10). In some embodiments, as the label is retrieved, a new label moves into position for subsequent retrieval by the gripper. In some embodiments, adhesive may be applied to the label prior to retrieval by the gripper, such as with an in-line adhesive application system. The gripper releasably and minimally contacts the adhesive side (18) of the label (6) by means of a plurality of pointed protrusions. The pointed protrusions may, for example, comprise a line of pins or bed of pins (16) or pin-like elements. The plurality of pointed protrusions releasably contacts the label. Contact is sufficient to hold the label in place but with sufficiently small surface contact to allow the label to be released upon application to the package (30). One or more applicators may comprise a first applicator (14) which may assist with feeding the label (6) from the gripper (10) onto the package (30) and lightly securing it in place. A second applicator (12), which may be a roller, plunger or any suitable element depending on the package shape, may securely apply the label onto the package.

Movement of the gripper head (4) which comprises the gripper (10) and the one or more applicators may be actuated by means of a servo-controlled robot, such as a delta-type robot, with movement on the x, y and z axes.

RFID Inventory tracking may be used in conjunction with the label application system or apparatus. Optical character recognition (OCR) cameras may be installed to assist in tracking packages. For example, each label may include a unique serial number, so the presence of a camera or scanner would assist in reconciling/keeping track of packages and labels before and after label application.

The apparatus may further comprise one or more control computers connected to the label application system or apparatus. The control computer(s) may be programmed with the parameters of various packages, thus enabling the label application system to manage a variety of package sizes and shapes as needed. The programming may be done on-site or remotely.

Control of the apparatus or system may be implemented in any combination of hardware and/or software as is considered advantageous and desirable. The control computer may be a single computer or may comprise plurality of computers interfaced to each other. In addition, any of the functionality described may be embodied in computer software instructions residing in a memory or a computer-readable medium in communication with a computer, or may alternatively be embodied in special-purpose hardware specifically constructed to perform such functionality. In general, a person skilled in the relevant art may implement the logical functionality of the various parts of the system described herein.

The embodiments of the invention disclosed herein are exemplary only, and various changes and modifications can be made without departing from the spirit and scope of the invention. The scope of the invention is indicated in the appended claims, and all changes that come within the meaning and range of equivalents are intended to be embraced therein.

1. An automated label application apparatus for labeling an object comprises:
a gripper for retrieving the label, wherein the gripper releasably and minimally contacts an adhesive side of the label; and
one or more applicators for applying the label onto the object;
wherein movement of the gripper and/or one or more applicators is actuated by a servo-controlled robot.

2. The automated label application apparatus of claim 1, wherein the gripper comprises a plurality of pointed protrusions.

3. The automated label application apparatus of claim 1, wherein the servo-controlled robot actuates a gripper head comprising the gripper and the one or more applicators.

4. The automated label application apparatus of claim 1, wherein the gripper is movable between open and closed positions.

5. The automated label application apparatus of claim 2, wherein the plurality of pointed protrusions are arranged in at least two rows, with each row comprising at least three pointed protrusions.

6. A method for automatically applying labels to objects comprises the steps of:
providing a label;
retrieving and gripping the label by means of a gripper, the gripper releasably and minimally contacting an adhesive side of the label;
guiding the label to the package; and
applying the label to the package by means of one or more applicators,
wherein the gripper and the one or more applicators are actuated by a servo-controlled robot.

7. The method of claim 6, wherein the gripper comprises a plurality of pointed protrusions.

8. The method of claim 6, wherein the gripper is movable between open and closed positions.

9. The method of claim 7, wherein the plurality of pointed protrusions are arranged in at least two rows, with each row comprising at least three pointed protrusions.
